(19) United States
(12) Patent Application Publication
(10) Pub. No.: US 2020/0370542 A1
(43) Pub. Date: Nov. 26, 2020

(54) GEARBOX USED IN WHEEL ASSEMBLIES WITH VARIABLE LEVEL OF VIBRATION

(71) Applicant: Alchemy20 Workshop Limited, Hong Kong (HK)

(72) Inventor: Victor Wai Tat Leung, Hong Kong (HK)

(21) Appl. No.: 16/421,183

(22) Filed: May 23, 2019

(51) Int. Cl. F03G 1/10; F16H 1/10; F03G 1/02; A63H 29/04

(52) U.S. Cl. CPC F03G 1/10; F16H 1/10; F03G 2730/01; A63H 29/04; F03G 1/02

(57) ABSTRACT

According to embodiments of the disclosed technology, systems and methods are provided for a mobile gateway I.T. system that is configured to receive a message from a source for transmission to a destination and multiple varying communication channels on which to transmit the message to the destination. The system may use a logic control library that is tightly coupled to the mobile gateway and the communication channels. The logic control library may be configured to select a first communication channel from the communication channels to route the message for transmission to the destination. The logic control library may be further configured to select a second communication channel from the communication channels to route the message for transmission to the destination in response to a period of time expiring without receiving a confirmation protocol from the destination via the first communication channel.

### FIELD OF THE INVENTION

The presently disclosed technology generally relates to pull back toy cars, and more specifically to uses of a gearbox contained inside an wheel assembly in order to create vibration sensitivity to enhance user experiences.

### BACKGROUND OF THE DISCLOSED TECHNOLOGY

Toy vehicles are numerous and have existed for many years. Self-propelled or pulled-back toy vehicles have been developed that contain a mechanism for driving the toy vehicle forward without requiring manual force. Many self-propelled toy vehicles have simple mechanisms and propulsion devices that lack durability or require expensive, complex electronics. A simple, inexpensive spring-powered toy vehicle but offering new and interesting features is fun for children to play with would be welcomed by children and the toy industry.

Traditionally, a self-propelled or pulled back toy vehicle come with a gearbox unit fixed to the body of a car. After the toy vehicle is pulled backward, the coil inside the gearbox will be wound up. The potential energy stored, when the toy vehicle is let go, will be released. The energy will be transferred to drive an output shaft, the rotation of which will cause the wheels and subsequently the toy vehicle move forward.

However, over the years producers or designers pay little attention in adding new features to pull back toy vehicles, Adding more play features including how to make pull back toy cars to create more vibrations associated with the wheels of the toy cars would create more fun play and be more entertaining to the toy industry.

### SUMMARY OF THE INVENTION

According to embodiments of this invention, a wheel assembly is disclosed for use in a pull back toy vehicle. The wheel assembly includes a case unit, a wheel axle, and a gearbox unit, In one embodiment, the case unit is formed as a shape of circle or a wheel, The wheel assembly also includes a wheel axle allowing the case unit to rotate along the wheel axle. The wheel assembly further includes a gearbox unit that is fixedly attached inside the case unit.

Further in the embodiment, the gearbox unit described above includes a coil spring that is retractable. Further, the coil spring does not create any contact with the wheel axle, no matter directly, or indirectly through any gears or shafts. The coil spring is wind up when the wheel assembly is pulled backward and when released, the coil spring would unwind and propel the toy vehicle forward, as energy stored during pull back gets released during forward motion.

The gearbox in the embodiment further includes an output shaft producing rotational motion when the coil spring unwinds from its retracted position. Similarly, the output shaft does not create any contact with the wheel axle directly, or indirectly through any other gears or shafts. The output shaft is positioned inside the wheel assembly at a distance away from the wheel axle or center point of the wheel assembly. The output shaft, as it rotates, causes the wheel assembly to rotate at a pivotal point other than the center point of the wheel assembly, resulting the wheel assembly rotate at a varying vertical axis relative to ground, which causes an effect of bumpy rotational movement when the wheel assembly rotates.

As an additional embodiment, the pull back toy vehicle is disclosed, including the embodied wheel assembly as a single, standalone wheel pull back toy vehicle.

According to a different embodiment, a wheel assembly offering variable levels of vibration with pull back toy vehicle capability is provided. The wheel assembly includes a case unit, a wheel axle, and a gearbox unit. The case unit is formed of a shape of a circle or a wheel. The wheel axle allows the case unit to rotate. The provided gearbox unit further includes: a coil spring, an output shaft, and a handle. The gearbox unit is movably attached inside the case unit, which further includes a coil spring that is retractable. The coil spring does not create any contact with the wheel axle directly, or indirectly through gears or shafts. The coil spring is wind up when the wheel assembly is pulled backward. When released, the coil spring unwinds and propels the toy vehicle forward, as energy stored during pull back gets released during forward motion.

The gearbox unit in this embodiment includes an output shaft, which produces rotational motion when the coil spring unwinds from its retracted position. The output shaft is contactless with the wheel axle directly, or indirectly through other gears or shafts. Further, the output shaft is positioned inside the wheel assembly at a distance away from the wheel axle or center point of the wheel assembly; and the output shaft would cause the wheel assembly to rotate at a pivotal point other than the center point of the wheel assembly, resulting the wheel assembly to rotate at a varying vertical axis relative to ground, which causes an effect of bumpy rotational movement when the wheel assembly rotates.

The gearbox unit in this embodiment includes a handle, which allows the gearbox unit to be placed on a different location within the car assembly unit. During rotation of the output shaft, the wheel assembly would rotate and vibrate in a different manner.

As an embodied feature, the handle of the wheel assembly is made movable such that the output shaft is farther away from the wheel axle causing variable vibration effects.

As a separate embodied feature, the handle of the wheel assembly is made movable such that rest of the gearbox unit is moved to a different location causing a shift of moment of inertia in terms of resulting rotation effect of the wheel assembly relative to ground.

According to a different embodiment, a toy vehicle offering pull back features with adjustable, variable level of vibration is provided. The embodied toy vehicle discloses a wheel and a wheel assembly, which includes case unit, a wheel axle, a gearbox; and a handle.

In the embodiment, the case unit is formed of a shape of circle or a wheel. The wheel axle allows the case unit to rotate. The gearbox unit is made movable and is attached inside the case unit. The gearbox includes a coil spring that is retractable. The coil spring is wind up when the wheel assembly is pulled backward. When released, the coil spring unwinds and propels the toy vehicle forward, as energy stored during pull back gets released during forward motion.

The gearbox unit further includes an output shaft producing rotational motion when the coil spring unwinds from its retracted position. The output shaft does not make contact to the wheel axle and is positioned inside the wheel assembly at a distance away from the wheel axle or center point of the wheel assembly. The output shaft causes the wheel assembly to rotate at a pivotal point other than the center point of the wheel assembly, resulting the wheel assembly to rotate at a different axis relative to ground, which causes an effect of bumpy rotational movement when the wheel assembly rotates.

The gearbox unit includes a handle allows the gearbox unit to be placed on a different location within the car assembly unit. During rotation of the output shaft, the wheel assembly would rotate and vibrate in a different manner.

In one related embodiment, a toy pull back vehicle is provided, and includes 2 assembly wheels as disclosed in this invention as a 2-wheels, front and back toy vehicle that offers various vibrations whose level are changeable by a user.

In another related and separate embodiment, a toy pull back vehicle is provided, and includes 4 assembly wheels as disclosed in this invention as a 4-wheels, a toy vehicle that offers various vibrations in that the vibration of each wheel can be different and whose level of vibration is is changeable by a user.

### BRIEF DESCRIPTION OF THE DRAWINGS

FIG. 1 refers to a prior art gearbox that has been traditionally used in pull back cars.

FIG. 2 refers to the internal structure of a prior art pull back toy car showing how a gearbox is connected to the axle of a wheel of the pull back toy car.

FIG. 3-5 refer to side views of the internal structures of a wheel assembly, consistent with embodiments of the present invention.

FIG. 6-8 refer to perspective views of the internal structures of a wheel assembly containing a handle in order to vary the location of the gearbox contained therein, consistent with embodiments of the present invention.

FIG. 9-11 refer to side views of the internal structures of a wheel assembly each containing a handle in order to vary the location of the gearbox contained therein, consistent with embodiments of the present invention.

FIG. 12 refers to embodied toys that each use a wheel assembly as a body part of the toy, consistent with embodiments of the present invention. A better understanding of the disclosed technology will be obtained from the following detailed description of embodiments of the disclosed technology, taken in conjunction with the drawings.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

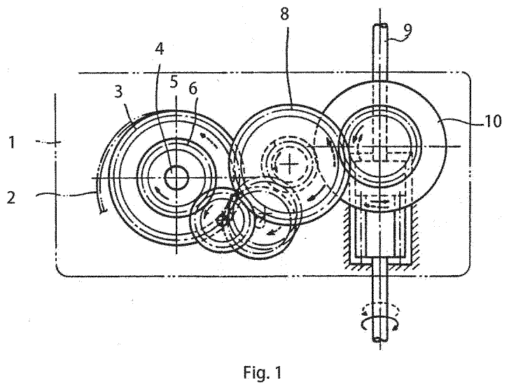

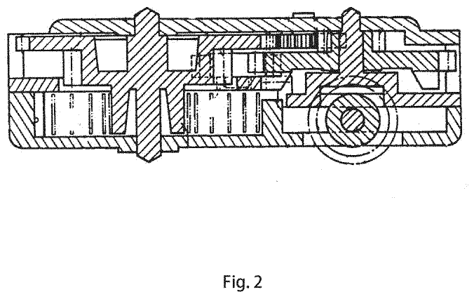

FIG. 1 refers to a prior art gearbox that has been used as a motor in a pull back toy vehicle disclosed in FIG. 2 as a prior art toy vehicle. In a typical pull back toy vehicle, the gearbox case (1) is fixed attached to the chassis of the toy vehicle (FIG. 2). The gearbox case (1) includes a coil (2) that is retractable, so that when a user pulls back the toy vehicle, the coil is retracted so that energy is stored within the coil. As can be seen, a coil is formed with an outer coil(3), coil center (4), coil axels (5), and an inner coil (6). When the user releases the car, the retracted coil is released so that gear members (8, 10) connected to the coil are rotated at the same time, which in turn causes the output shaft (9) to rotate. The rotation by the output shaft(9) either directly or indirectly connected (through gears) to an axle member which in turn drive rotation of any wheels attached to the axle and subsequently causes the pull back toy vehicle to move forward.

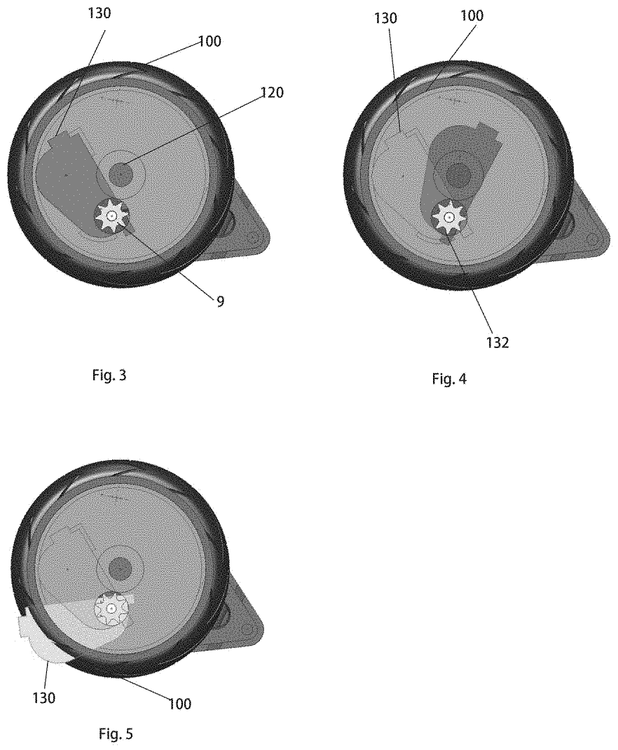

FIGS. 3-5 disclose a wheel assembly (100), consistent with examples of the present invention, The wheel assembly (100) is disclosed for use in a pull back toy vehicle (1000).

The wheel assembly (100) includes a case unit (110), a wheel axle (120), and a gearbox unit (130). As a preferred example, the case unit (110) is formed as a shape of circle or a wheel. The wheel assembly (100) also includes a wheel axle (120) allowing the case unit (110) to freely rotate along the wheel axle (120). The wheel assembly (100) further includes a gearbox unit (130) that is fixedly attached inside the case unit (110).

The gearbox unit (130) described above includes a coil spring that is retractable. The coil spring however does not create any contact with the wheel axle (120), no matter directly, or indirectly through any gears or shafts. The coil spring is wind up when the wheel assembly (100) is pulled backward and when released, the coil spring would unwind and propel the toy vehicle (1000) forward, as energy stored during pull back gets released during forward motion.

The gearbox further includes an output shaft (132) producing rotational motion when the coil spring unwinds from its retracted position. Similarly, the output shaft (132) does not create any contact with the wheel axle (120) directly, or indirectly through any other gears or shafts. The output shaft (132) is positioned inside the wheel assembly (100) at a distance away from the wheel axle (120) or center point of the wheel assembly (100). The output shaft (132), as it rotates, causes the wheel assembly (100) to rotate at a pivotal point other than the center point of the wheel assembly (100), resulting the wheel assembly (100) rotate at a varying vertical axis relative to ground, which causes an effect of bumpy rotational movement when the wheel assembly (100) rotates.

As an additional example, the pull back toy vehicle (1000) is disclosed, including the implemented wheel assembly (100) as a single, standalone wheel pull back toy vehicle (1000).

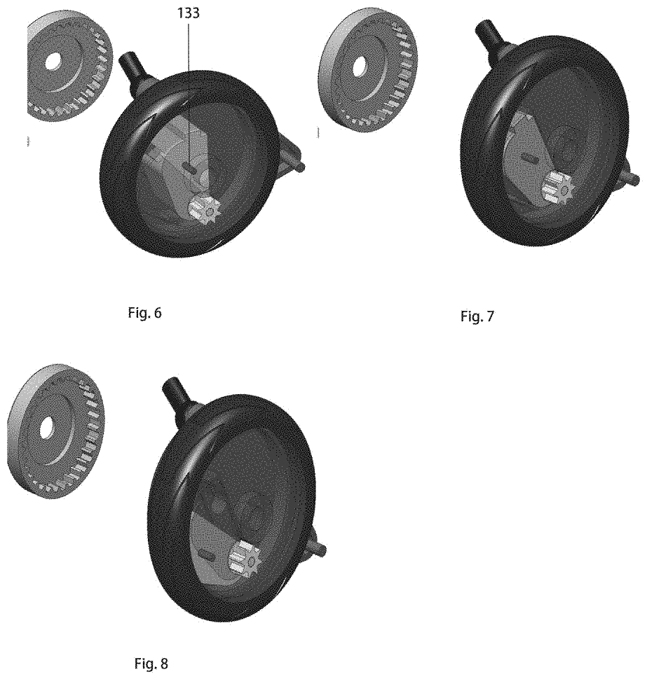

According to different examples as shown in FIGS. 6-8, a wheel assembly (100) offering variable levels of vibration with pull back toy vehicle (1000) capability is provided. The wheel assembly (100) includes a case unit (110), a wheel axle (120), and a gearbox unit (130). The case unit (110) is formed of a shape of a circle or a wheel. The wheel axle (120) allows the case unit (110) to rotate. The provided gearbox unit (130) further includes: a coil spring, an output shaft (132), and a handle (133). The gearbox unit (130) is movably attached inside the case unit (110), which further includes a coil spring that is retractable. The coil spring does not create any contact with the wheel axle (120) directly, or indirectly through gears or shafts. The coil spring is wind up when the wheel assembly (100) is pulled backward. When released, the coil spring unwinds and propels the toy vehicle (1000) forward, as energy stored during pull back gets released during forward motion.

The gearbox unit (130) in this example includes an output shaft (132), which produces rotational motion when the coil spring unwinds from its retracted position. The output shaft (132) is contactless with the wheel axle (120) directly, or indirectly through other gears or shafts. Further, the output shaft (132) is positioned inside the wheel assembly (100) at a distance away from the wheel axle (120) or center point of the wheel assembly (100); and the output shaft (132) would cause the wheel assembly (100) to rotate at a pivotal point other than the center point of the wheel assembly (100), resulting the wheel assembly (100) to rotate at a varying vertical axis relative to ground, which causes an effect of bumpy rotational movement when the wheel assembly (100) rotates.

The gearbox unit (130) in this example includes a handle (133), which allows the gearbox unit (130) to be placed on a different location within the car assembly unit. During rotation of the output shaft (132), the wheel assembly (100) would rotate and vibrate in a different manner.

As an implemented feature, the handle (133) of the wheel assembly (100) is made movable such that the output shaft (132) is farther away from the wheel axle (120) causing variable vibration effects.

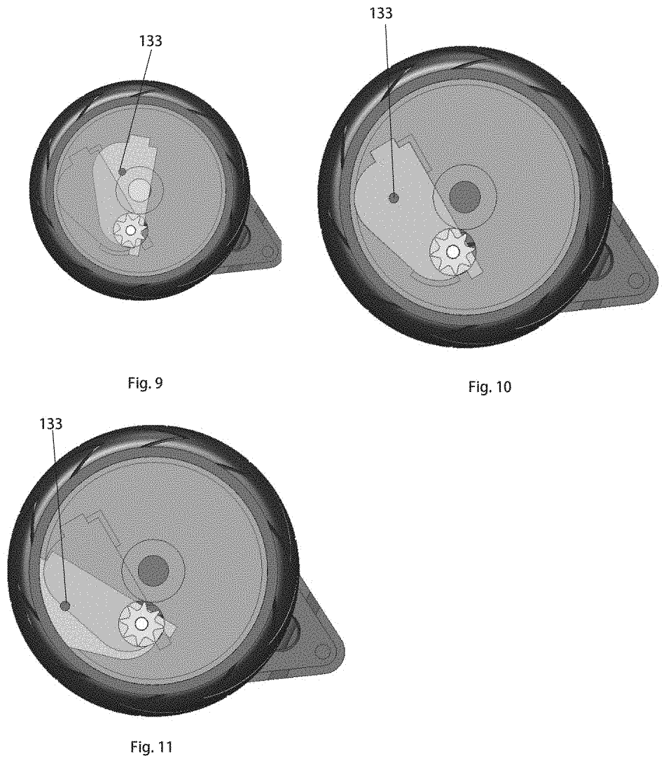

As a separate implemented feature which shown on FIGS. 9-11, the handle (133) of the wheel assembly (100) is made movable or rotatable such that rest of the gearbox unit (130) is moved to a different location causing a shift of moment of inertia in terms of resulting rotation effect of the wheel assembly (100) relative to ground.

According to a different example, a toy vehicle (1000) offering pull back features with adjustable, variable level of vibration is provided, The implemented toy vehicle (1000) discloses a wheel and a wheel assembly (100), which includes case unit (110), a wheel axle (120), a gearbox; and a handle (133).

In the example, the case unit (110) is formed of a shape of circle or a wheel. The wheel axle (120) allows the case unit (110) to rotate. The gearbox unit (130) is made movable and is attached inside the case unit (110). The gearbox includes a coil spring that s retractable, The coil spring is wind up when the wheel assembly (100) is pulled backward. When released, the coil spring unwinds and propels the toy vehicle (1000) forward, as energy stored during pull back gets released during forward motion.

The gearbox unit (130) further includes an output shaft (132) producing rotational motion when the coil spring unwinds from its retracted position. The output shaft (132) does not make contact to the wheel axle (120) and is positioned inside the wheel assembly (100) at a distance away from the wheel axle (120) or center point of the wheel assembly (100). The output shaft (132) causes the wheel assembly (100) to rotate at a pivotal point other than the center point of the wheel assembly (100), resulting the wheel assembly (100) to rotate at a different axis relative to ground, which causes an effect of bumpy rotational movement when the wheel assembly (100) rotates.

The gearbox unit (130) includes a handle (133) allows the gearbox unit (130) to be placed on a different location within the car assembly unit. During rotation of the output shaft (132), the wheel assembly (100) would rotate and vibrate in a different manner.

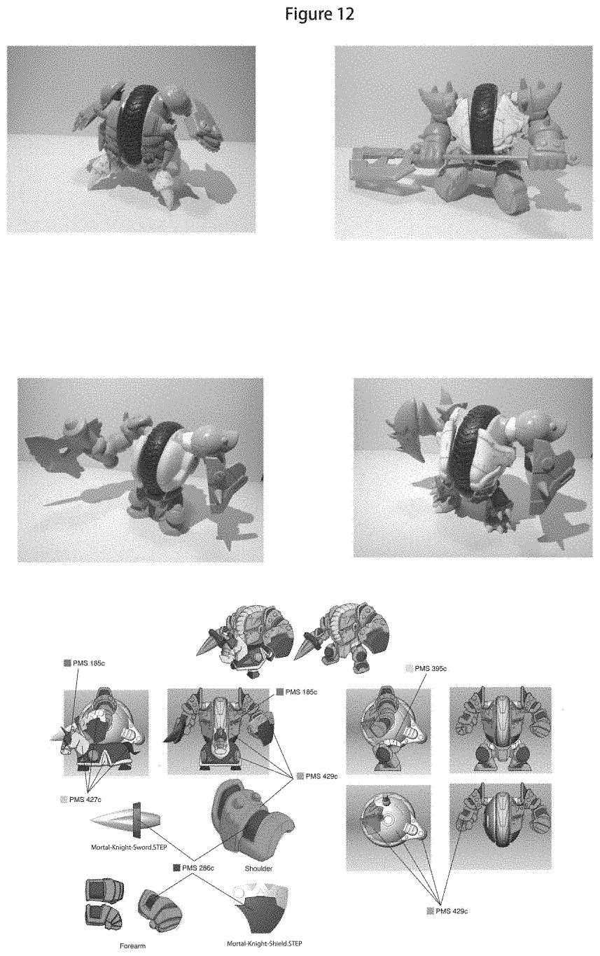

In one related example, a toy pull back vehicle is provided, and includes a 1-wheel toy vehicle, various looks are disclosed in FIG. 12.

In another example, a 2-wheel toy vehicle is disclosed in this invention as a 2-wheels, front and back toy vehicle (1000) that offers various vibrations whose level are changeable by a user.

In another related and separate example, a toy pull back vehicle is provided, and includes 4 assembly wheels as disclosed in this invention as a 4-wheels, a toy vehicle (1000) that offers various vibrations in that the vibration of each wheel can be different and whose level of vibration is changeable by a user.

Contrary to the prior art, the claimed inventions are different in many ways. First, the claimed wheel assembly contains the gearbox. This contrary to the prior art in that most pull back cars have the gearbox fixed onto a chassis and that the wheels in a typical pull back toy car have simple wheels that are caused to rotate by an axel that is caused to rotate by the attached gearbox through gear members or even directly driven by the output shaft of the gearbox. Second, by including the gearbox into wheel assembly, as disclosed in this invention, a variety of play set can be produced with great efficiency. For example, if the claimed wheel assembly is inserted on to a 2-wheel vehicle like a motor toy bike, the front and the back wheels can include their own gearboxes so that each can have different levels of vibrations ability. This can create more fun for pull back toy car users. In another implementation, for example, a typical 4 wheel pull back toy cars can use our inventive wheel assembly in one or two or there or even four of its wheel to create various level of play style.

1. (canceled)

2. (canceled)

3. (canceled)

4. (canceled)

5. (canceled)

6. (canceled)

7. (canceled)

8. (canceled)

9. A wheel assembly of a toy vehicle offering pull back features creating vibrations, comprising:
a case unit, where in the case unit is formed as a shape of circle or a wheel;
a wheel axle, where in the wheel axle allows the case unit to rotate; and
a gearbox unit fixedly attached inside the case unit, comprising:
a coil spring that is retractable, wherein:
the coil spring is contactless with the wheel axle directly, or indirectly through gears or shafts; and
the coil spring is wind up when the wheel assembly is pulled backward;
when released, the coil spring unwinds and propels the toy vehicle forward, as energy stored during pull back gets released during forward motion;
an output shaft producing rotational motion when the coil spring unwinds from its retracted position, wherein the output shaft:
is contactless with the wheel axle directly, or indirectly through other gears or shafts;
is positioned inside the wheel assembly at a distance away from the wheel axle or center point of the wheel assembly; and
causes the wheel assembly to rotate at a pivotal point other than the center point of the wheel assembly, resulting the wheel assembly rotate at a varying vertical axis relative to ground, which causes an effect of bumpy rotational movement when the wheel assembly rotates.

10. The wheel assembly of claim 1, wherein the toy vehicle is a one wheel, standalone pull back vehicle.

11. A wheel assembly of a toy vehicle offering pull back features with adjustable, variable level of vibration, comprising:
a case unit, where in the case unit is formed at a shape of circle or a wheel;
a wheel axle, where in the wheel axle allows the case unit to rotate; and
a gearbox unit movably attached inside the case unit, comprising::
a coil spring that is retractable, wherein:
the coil spring is contactless with the wheel axle directly, or indirectly through gears or shafts;
the coil spring is wind up when the wheel assembly is pulled backward; and
when released, the coil spring unwinds and propels the toy vehicle forward, as energy stored during pull back gets released during forward motion;
an output shaft producing rotational motion when the coil spring unwinds from its retracted position, wherein the output shaft:
is contactless with the wheel axle directly, or indirectly through other gears or shafts;
is positioned inside the wheel assembly at a distance away from the wheel axle or center point of the wheel assembly; and
causes the wheel assembly to rotate at a pivotal point other than the center point of the wheel assembly, resulting the wheel assembly to rotate at a varying vertical axis relative to ground, which causes an effect of bumpy rotational movement when the wheel assembly rotates; and
a handle allows the gearbox unit to be placed on a different location within the car assembly unit, wherein during rotation of the output shaft, the wheel assembly would rotate and vibrate in a different manner.

12. The wheel assembly in claim 3, wherein the handle is moved such that the output shaft is farther away from the wheel axle, resulting the wheel assembly to rotate at a different vertical axis relative to ground, which causes a stronger or weaker effect of bumpy rotational movement when the wheel assembly rotates.

13. The wheel assembly in claim 3, wherein the handle is pivoted by a user in such a way that i) the distance between the output shaft and the wheel axle remains the same and ii) rest of the gearbox unit is moved to a different location causing a shift of moment of inertia in terms of resulting rotation effect of the wheel assembly relative to ground, which causes a weaker or stronger effect of bumpy rotational movement as the wheel assembly rotates.

14. A toy vehicle offering pull back features with adjustable, variable level of vibration, comprising:
a wheel consisting of a wheel assembly comprising:
a case unit, where in the case unit is formed at a shape of circle or a wheel;
a wheel axle, where in the wheel axle allows the case unit to rotate; and
a gearbox unit movably attached inside the case unit, comprising:
a coil spring that is retractable, wherein:
the coil spring is wind up when the wheel assembly is pulled backward; and
when released, the coil spring unwinds and propels the toy vehicle forward, as energy stored during pull back gets released during forward motion;
an output shaft producing rotational motion when the coil spring unwinds from its retracted position, wherein:
the output shaft: does not make contact to the wheel axle;
is positioned inside the wheel assembly at a distance away from the wheel axle or center point of the wheel assembly; and
causes the wheel assembly to rotate at a pivotal point other than the center point of the wheel assembly, resulting the wheel assembly to rotate at a different axis relative to ground, which causes an effect of bumpy rotational movement when the wheel assembly rotates; and
a handle allows the gearbox unit to be placed on a different location within the car assembly unit, wherein during rotation of the output shaft, the wheel assembly would rotate and vibrate in a different manner.

15. The toy vehicle of claim 6, wherein the toy vehicle is a 2-wheel vehicle, comprising:
a front wheel made of the wheel assembly; and
a back wheel made of the wheel assembly, wherein the handle of back wheel of the wheel assembly is moved by the user to a different location within the car assembly unit of the back wheel from the front wheel, such that during rotation each of the front wheel and back wheel would rotate at different vertical axis relative to the ground further enhancing vibration movement between the front and the back of the toy vehicle.

16. The toy vehicle of claim 7, wherein the toy vehicle is a 4-wheel vehicle, comprising:
a front left wheel made of the wheel assembly in which the gearbox unit inside the case unit is placed in an independent first position, wherein the handle of wheel is moved by the user such that the front left wheel rotates at a style relative to the vertical axis of the ground;
a front right wheel made of the wheel assembly in which the gearbox unit inside the case unit is placed in an independent second position, wherein the handle of wheel is moved by the user such that the front right wheel rotates at a style different from the front left wheel relative to the vertical axis of the ground;
a rear left wheel made of the wheel assembly in which the gearbox unit inside the case unit is placed in an independent third position, wherein the handle of wheel is moved by the user such that the rear left wheel rotates at a styled different from the front left wheel and front right wheel relative to the vertical axis of the ground; and
a rear right wheel made of the wheel assembly in which the gearbox unit inside the case unit is placed in an independent fourth position, wherein the handle of wheel is moved by the user such that the rear left wheel rotates at a styled different from the front left wheel, front right wheel, and rear left wheel relative to the vertical axis of the ground.
